(19) United States
(12) Patent Application Publication
(10) Pub. No.: US 2026/0097507 A1
(43) Pub. Date: Apr. 9, 2026

(54) CONTROL NODE AND METHOD PERFORMED THEREIN

(71) Applicant: Telefonaktiebolaget LM Ericsson (publ), Stockholm (SE)

(72) Inventors: Sándor RÁCZ, Cegléd (HU); Norbert REIDER, Tényö (HU)

(21) Appl. No.: 19/114,848

(22) PCT Filed: Oct. 13, 2022
(86) PCT No.: PCT/SE2022/050928

§ 371 Date: Mar. 25, 2025

(51) Int. Cl. B25J 9/16

(52) U.S. Cl. CPC B25J 9/1674

(57) ABSTRACT

A method performed by a control node for handling communication with a robot device. The control node determines a distance from a planned trajectory and/or path, and a distance from a boundary surface, which distances are related to a command message received from a robot device, wherein the boundary surface is associated to an accuracy requirement. The control node further measures a performance of the trajectory based on the determined distance from the planned trajectory and/or path and from the boundary surface. The control node further evaluates an effect of the measured performance for the robot device.

### TECHNICAL FIELD

Embodiments herein relate to a control node and a method performed therein. Furthermore, a computer program and a computer readable storage medium are also provided herein. In particular, embodiments herein relate to handling performance of a robot device.

### BACKGROUND

In general, robotic devices of a robot support different types of control commands. For example, robotic devices such as robotic arms may support velocity commands in joint-space, i.e., rotation velocity of servos in radian per second, and also in Cartesian-space, i.e., velocity in 3D space in m/s. A servo motor, also referred to as servo or servo motor, is a rotary actuator that allows for precise control of angular position, velocity and acceleration.

Commands in robotics define high-level robot actions or behaviours that utilize the methods defined by the subsystems. A command is a simple state machine that is either initializing, executing, ending, or idle.

Closed-loop communication is the process of acknowledging the receipt of information and clarifying with the sender of the communicated message that the information received is the same as the original, intended information.

Closed-loop control systems use feedback, from e.g. sensors or transducers, to regulate input for the accuracy of output results. Closed-loop control systems are found in many industrial and commercial applications to maintain quality, accuracy, and productivity.

Traditional robotic applications assume wired connection with negligible loss and/or delay and/or jitter within the closed-loop control of servos. Wireless connection usually does not provide as good quality connection as a wired connection. The closed-loop control may be moved into an edge cloud and the wired connection may be replaced with wireless connection. An edge cloud architecture may be used to decentralize power to the edges, e.g. clients and/or devices, e.g. clients of devices, of a network. The edge cloud control over a wireless connection may be advantageous in several use-cases, including:
On-line control of Autonomous Guided Vehicles (AGVs), where the environment may change rapidly, and trajectory may be redesigned frequently.
Coordinated movement of two or more robotic arms, where the precise movement may be considered relative to each other.
Human-robot collaboration, where rapid reactions to human actions may be crucial.

The wireless connection may also have effect on a performance of a closed-loop control. For a wireless connection the packet loss and/or delay and/or jitter may not be eliminated by the nature of wireless signal propagation.

### SUMMARY

An object of embodiments herein is to provide an improved way of handling a performance of a robot device in an efficient manner.

According to an aspect of embodiments herein the object may be achieved by a method performed by a control node for handling a performance of a robot device. The control node determines a distance between a planned trajectory and/or path, and a boundary surface, which distance is related to a command message received from a robot device, wherein the boundary surface is associated to an accuracy requirement. The control node further measures a performance of the trajectory based on the determined distance from the planned trajectory and/or path and from the boundary surface. The control node then further evaluates an effect of the measured performance for the robot device.

According to another aspect of embodiments herein, the object is achieved by providing a control node for handling a performance of a robot device. The control node is configured to a distance between a planned trajectory and/or path, and a boundary surface, which distance is related to a command message received from a robot device, wherein the boundary surface is associated to an accuracy requirement. The control node is further configured to measure a performance of the trajectory based on the determined distance from the planned trajectory and/or path and from the boundary surface. The control node is then further configured to valuate an effect of the measured performance for the robot device.

It is furthermore provided herein a computer program comprising instructions, which, when executed on at least one processor, cause the at least one processor to carry out the method above, as performed by the control node. It is additionally provided herein a computer-readable storage medium, having stored thereon a computer program comprising instructions which, when executed on at least one processor, cause the at least one processor to carry out the method above, as performed by the control node.

Embodiments herein are based on the realisation that a performance of an application, e.g. communication between a control node and a robot device, may be optimized when the effect of the performance is measured, and the application is informed about it. Therefore, by determining a performance measure by measuring the performance of the trajectory, e.g. performance of the trajectory execution, based on the determined distance from the planned trajectory and/or path and from the boundary surface, the performance measure for the robot device can be evaluated. This evaluation may then be used to measure a quality of execution of the planned trajectory and/or to monitor a performance of the robot device. Thereby an improved way of handling a performance of a robot device in an efficient manner is achieved.

### BRIEF DESCRIPTION OF THE DRAWINGS

Embodiments will now be described in more detail in relation to the enclosed drawings, in which:

FIG. 1 illustrates a schematic overview of embodiments herein;

FIG. 2 is a flowchart depicting a method performed by a control node according to embodiments herein;

FIG. 3 is a schematic overview illustrating an example of embodiments herein;

FIG. 4 is a flowchart illustrating an example of embodiments herein;

FIG. 5 is a schematic overview illustrating another example of embodiments herein;

FIG. 6 is a flowchart illustrating another example of embodiments herein;

FIG. 7 is a flowchart illustrating another example of embodiments herein;

FIG. 8 is a flowchart illustrating another example of embodiments herein; and

FIG. 9 is a block diagram depicting a control node according to embodiments herein;

It should be noted that the drawings have not necessarily been drawn to scale and that the dimensions of certain elements may have been exaggerated for the sake of clarity.

### DETAILED DESCRIPTION

Embodiments herein are described in more detail below with reference to the appended figures, in which examples of embodiments are shown. Embodiments herein are not limited to the described examples of embodiments herein, they are rather defined by the appended patent claims. Like numbers in the figures refer throughout to like elements.

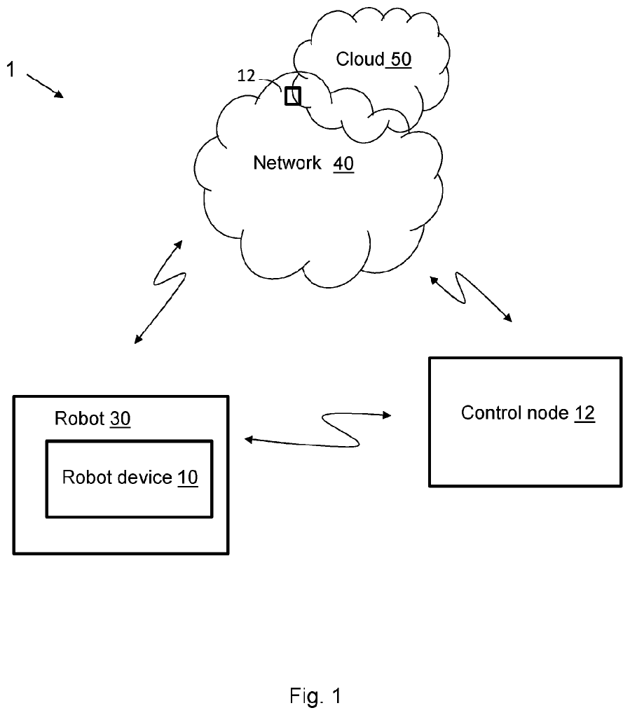

FIG. 1 illustrates a schematic overview of embodiments herein comprising a system 1. The system 1, e.g. a control system for controlling one or more robots, may include one or more different subsystems performing one or more functions or operations. The system 1 comprises one or more control nodes, such as a control node 12, adapted to control one or more robots, such as a robot 30. The robot 30 comprises one or more robot devices, such as robot device 10, e.g., one or more robot arms or links of robot arms. The robot device 10 may also be referred to as robotic device and the robot arms may also be referred to as robotic arms.

Methods herein may be performed by the control node 12. The control node 12 may be a controller such as a Proportional Integral Derivative (PID) controller. The control node 12 may be placed on the robot 30 and calculations, operations, etc. may then be made locally. The control node 12 may also be located at a remotely located control room. The control node 12 may enable communication with or control of the one or more robots 30, e.g. by wired or wireless data links directly or across one or more communication networks 40. The control node 12 may further be located in a cloud 50.

According to embodiments herein the control node 12 determines a distance from a planned trajectory and/or path, and from a boundary surface, for a received feedback message from the robot device 10, wherein the boundary surface is associated to an accuracy requirement. The control node 12 then determines a performance measure based on the determined distance from the planned trajectory and/or path and from the boundary surface and then evaluates the performance measure for the robot device 10.

Embodiments herein may concern a performance monitoring of closed-loop control of the robot device 10, e.g. over a wireless connection from e.g. an edge-cloud. An edge cloud architecture may be used to decentralize, e.g. process, power to the edges, e.g. clients and/or devices, of the communication network 40. Embodiments herein enable that deviation from the planned trajectory is minimized.

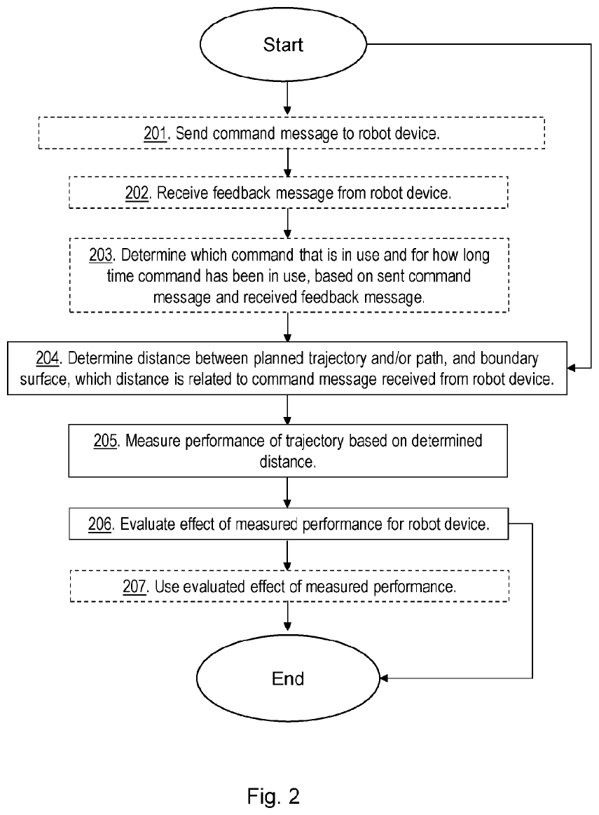

The method actions performed by the control node 12 for handling the performance of the robot device 10, e.g., a robot arm, according to embodiments herein, will now be described with reference to a flowchart depicted in FIG. 2. The actions do not have to be taken in the order stated below, but may be taken in any suitable order. Actions performed in some embodiments are marked with dashed boxes.

The method actions below may focus on two groups of performance measures:

1) Path/trajectory distance measures that consider one or more accuracy requirements. For each feedback message where position information is available, the control node 12 determines the distance from the planned trajectory/path and also from the boundary surface that formulates an accuracy requirement. The provided performance measure is a function of these two distances. The performance measure for each robot device 10, e.g. each link of a robotic arm, may be measured separately and may take a maximal value as a single measure.

2) Timing information of feedback and command message. May also be referred to as control-loop state monitoring.

In each command message a unique hash value may be included. The control node 12 may reflect this hash value in the feedback message. Based on the sent and received hash values, the control node 12 may determine which command that is in use and for how long time the command is in use.

Action 201. The control node 12 may send a command message to the robot device 10. The robot device 10 may be a link of a robot arm. The command message may comprise a unique hash value. Any identifier (ID) may be used that is unique for each command message. For example a hash value may be a result of applying a hash function on an identifier of the servo motor of the robot 30 concatenated with the actual time in microseconds. A hash function is a function that maps data of arbitrary size to fixed-size values.

Action 202. The control node 12 may receive the command message as a feedback to the sent command message, from the robot device 10. This may be a response to the command message. The feedback message may comprise the unique hash value.

The control node 12 and a servo motor associated to the robot device 10 may have synchronized clocks. The servo motor may e.g. be an actuator.

Action 203. The control node 12 may then determine which command that is in use and for how long time the command has been in use, based on the sent command message and the received feedback message comprising the unique hash value.

Due to the actions 201-203 the control node 12 may calculate the next control command accurately if it is aware of the delay in a command execution and if it is aware of any late commands applied by the actuators of the robot 30. This may be used in the below actions to optimize the communication between the control node 12 and the robot device 10.

Action 204. To enable the control node 12 to optimize the performance of the communication with the robot device 10, the performance first needs to be measured. The control node 12 therefore determines the distance between a planned trajectory and/or path, and a boundary surface, which distance is related to the command message received from the robot device 10. The boundary surface is associated to an accuracy requirement. The boundary surface when used herein may be defined as a maximum tolerable deviation from the planned trajectory. An example of an accuracy requirement may be that 1 mm deviation from the planned trajectory is allowed.

The determined distance from the planned trajectory and/or path, and from the boundary surface may be calculated in a Cartesian space. This means that the distance itself may be calculated in the Cartesian space, i.e., in 3D (X, Y, Z). It is the Euclidean distance of two points in 3D space and may be calculated based on the Pythagoras theorem: sqrt((x2-x1)\hat{ }2+ (y2−y1)\hat{ }2+(z2−z1) \hat{ }2).

A closest point of the planned path may be used to determine the path distance. The planned trajectory and a realized trajectory may be calculated at a same time point. The determined distance from the planned trajectory and/or path are measured for one or more points of the planned trajectory where measured position information is available.

Action 205. When the control node 12 knows the distance from the planned trajectory and/or path to the boundary surface, the control node 12 is able to determine the performance measure for the robot device 10. Therefore, the control node 12 measures a performance of the trajectory, e.g. measures a performance of the trajectory execution, based on the determined distance from the planned trajectory and/or path and from the boundary surface. E.g., the control node 12 determines the performance measure based on the determined distance from the planned trajectory and/or path and from the boundary surface. Measuring the performance of the trajectory, e.g. trajectory execution, based on the determined distance from the planned trajectory and/or path may comprise the distance between a tangent line of a given point of the realized trajectory and the planned trajectory. Measuring the performance of the trajectory, e.g., determining the performance measure, based on the determined distance from the boundary surface may comprise the distance between a tangent line of a given point of the realized trajectory and the boundary surface.

Action 206. The control node 12 then evaluates an effect of the measured performance for the robot device 10. Evaluating the effect of the performance may be based on the measured performance of the trajectory and may consequently also be based on the determined distance from the planned trajectory and/or path and based on the determined distance from the boundary surface.

Action 207. The control node 12 may use the evaluated performance measure for one or more of: to quantify a quality of execution of the planned trajectory, to monitor a performance of the robot device 10, and/or as trajectory execution quality features input to an artificial intelligence agent.

The actions 204-207 enables that the performance measure quantifies the accuracy of the robot device 10, and the control node 12 may take them into account so that the deviation from the planned trajectory is minimized. These measures may show the impact of network imperfections on the performance of the robot device and the robot 30 in the space domain.

Embodiments herein such as mentioned above will now be further described and exemplified. The text below is applicable to and may be combined with any suitable embodiment described above. The following quality performance measures may be included in a trajectory execution: the accuracy requirements and also a Cartesian position of each robot device 10.
The provided distance measures i.e., the distances from the planned trajectory and/or path, and the distance from the boundary surface, also referred to as spatial distance measures as related to measuring distances in space, may be used to quantify the quality of trajectory execution, monitoring of overall performance including imperfection and/or unmodelled behaviour of all components in a control loop including network connection.
Network 40 imperfection may be measured by comparing spatial distance measures with baseline measurements recorded over e.g., wired connection. Baseline measurements may be defined as measurements of suitable metrics when the robot 30 is connected over wired connection instead of wireless.
Spatial distance measures may be used as input in an Artificial Intelligence (AI) agent as trajectory execution quality features, e.g., fine-tuning an algorithm of the control node 12.

Control-loop state monitoring may have the following advantages:
Control-loop state, e.g. a time of a command in use, such as for how long time the command has been in use, may allow to monitor network imperfection from a control loop point of view.
A combination of control-loop state and spatial distance measures may be used to quantify an effect of network imperfection on trajectory execution quality. This combination may be performed by the control node 12.
Control-loop state and spatial distance measures may be used in an AI agent as features for network imperfection, e.g., to fine-tune an algorithm of the control node 12.

Further advantages that may be achieved with the embodiments herein are accurate and comprehensive monitoring of the performance of the robot 30 and the robot device 10 and the efficiency of the control node 12.

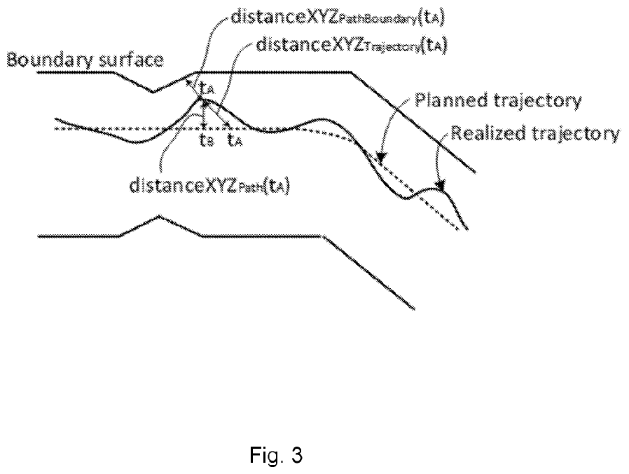

FIG. 3 illustrates an example of embodiments herein. FIG. 3 shows a segment of the robot device 10 with considered distances. These distances may be considered, e.g., determined or calculated, in the Cartesian space. In case of trajectory distance, denoted by distanceXYZTrajectory, the realized and the planned trajectory may be considered at the same time point. The term DistanceXYZTrajectory thus relate to the distance between the planned and the realized trajectory. A realized trajectory may be the trajectory that is actually executed by the robot 30. There may be differences between a trajectory planned by the control node 12, i.e., planned trajectory, and a trajectory actually realized by the robot device 10, i.e., realized trajectory, due to unmodelled or inaccurately modelled factors in the control node 12. Meanwhile in case of the path distance, denoted distanceXYZPath, the closest point of the planned trajectory may be used to calculate the distance.

The distanceXYZTrajectory and distanceXYZPath measures may be calculated for each point of a trajectory where measured position information is available. From the measured joint position of the robot device 10 position may be calculated using a forward kinematics formula of the robot device 10 and/or the robot 30. Then:
distanceXYZTrajectory: the measured Cartesian position may be compared with the planned position and a distance may be calculated.
distanceXYZPath: in this case the measured position may be compared with several planned trajectory points and the minimal distance may be taken. For example, at 2.5 sec. of the trajectory. In addition to calculating the distance to a planned trajectory value at 2.5 sec. addition may be taken appoint of the planned trajectory between for example 1.5 sec. and 3.5 sec. In this case a shortest distance of the measured point may be calculated to a segment of the trajectory, i.e., a shortest distance from a point to a line.

This may also mean that the path distance may be less or equal than the trajectory distance because the path distance does not take into account the timing of the trajectory. If the timing of the trajectory is important then trajectory distance may be used. When only the path of the movement is important the path distance may be the right measure.

The boundary surface represents a spatial accuracy requirement from trajectory execution. This may be provided by a trajectory planner in addition to a planned trajectory. This may be a simple static surface. For example, it may be defined by the maximal allowed deviation from the planned trajectory, e.g. max 1 mm deviation. In this case this may be a tube with 1 mm radius following the planned trajectory. The boundary surface may be more complex, e.g. having an asymmetric shape, closer to planned trajectory where more accurate movement may be required. In case of coordinated movement, the central point of the boundary surface may be derived from the realized trajectory of the robot device 10.

The distanceXYZBoundary is the shortest distance between the current measured Cartesian position and the boundary surface of the trajectory, i.e., shortest distance between point and surface. DistanceXYZBoundary is thus the distance between the boundary surface and the realized trajectory. Each trajectory has a single boundary surface which expresses the spatial accuracy requirement. If we would like to include temporal accuracy requirement as well, then for different trajectory time points or different trajectory segments it may be possible to specify different boundary surfaces.

The performance measures may be determined, e.g., calculated, after execution of the trajectory to monitor the performance of the system. If an on-line action uses these performance measures the on-line calculation may be performed for every cycle period.

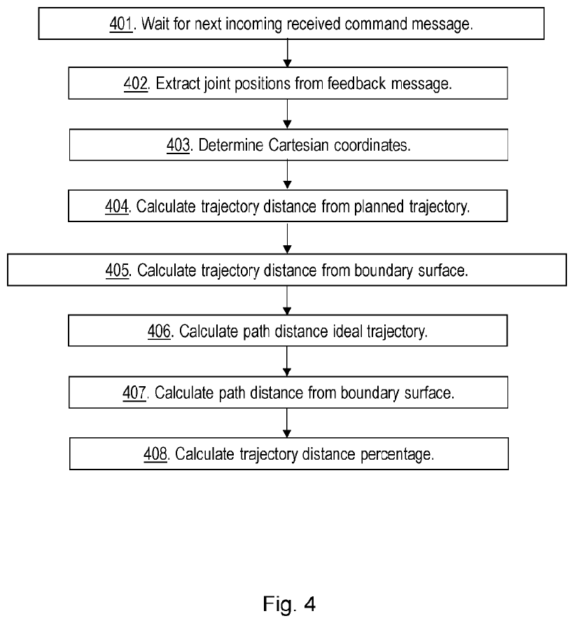

FIG. 4 depicts a flowchart showing actions performed by the control node 12 according to some embodiments herein. FIG. 4 shows an example which is executed at each received command message, e.g., feedback message. Each robot device 10, e.g. link of a robot arm, may be executed separately and then taking the worst deviation value. When a movement of a subset of the link is of value then those deviations may be calculated. The example in FIG. 4 provides a single value output with a percentage value, where distance TrajectoryPercentage=0% means that there may be no deviation from the planned trajectory or there is no requirement on accuracy. A value near to 100% means that the realized trajectory may be very close to the accuracy requirement. If the realized trajectory is outside of the boundary surface, then the distance to it may be assumed to be zero.

Action 401. Wait for a next incoming received command message.

Action 402. Extract joint positions, e.g. measuredJoint, from received command message, e.g. feedback message.

Action 403. Determine Cartesian coordinates, where:
measured XYZ=forward (measuredJoint),
trajectoryXYZ=forward (trajectory Joint)
Action 404. Calculate a trajectory distance from planned trajectory, where: distanceXYZTrajectory=L2 (measured XYZ, trajectoryXYZ)

Action 405. Calculate a trajectory distance from a boundary surface, where: distanceXYZBoundary=L2 (measuredXYZ, boundarySurface).

Action 406. Calculate a path distance ideal trajectory:
1. Calculate distances for segment of the trajectory.
2. Path distance (distance XYZPath) are the minimum values of calculated distances.

Action 407. Calculate a path distance from the boundary surface:
1. Calculate distances for set of boundary surfaces.
2. Path.boundary distance (distanceXYZPathBoundary) are the minimal values of calculated distances.

Action 408. Calculate a trajectory distance percentage:

$$distanceTrajectoryPercentage = distanceXYZTrajectory / ( distanceXYZTrajectory + distanceXYZBoundry ) , \\ distancePathPercentage = distanceXYZPath / ( distanceXYZPath + distanceXYZPathBoundry ) .$$

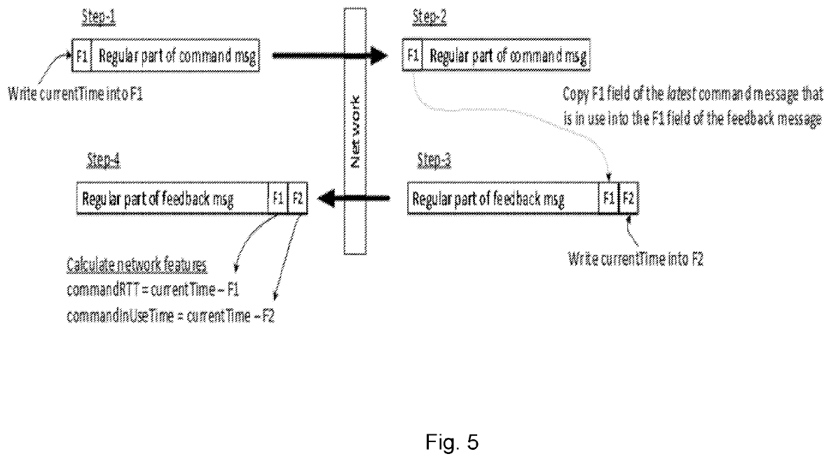

FIG. 5 illustrates a flowchart of an example performed by the control node 12 according to some embodiments herein. An example of measuring a time of the command in use, commandInUse Time, and also a round-trip time of the command is shown in FIG. 5. At step 1. A current control node 12 time may be added to each command message, in field F1. At steps 2-3. The servo motor associated to the robot device 10 may put the value of the F1 field of the in-use command into the command message, e.g., feedback message, and also put a current time in field F2. At step 4. In the control node 12 the commandRTT and commandInUseTime commands may be calculated based on the values of the F1 and F2 fields in the feedback message. The fields may be explicitly added to the command and/or feedback messages as new fields or may be encoded into existing fields to keep backward compatibility.

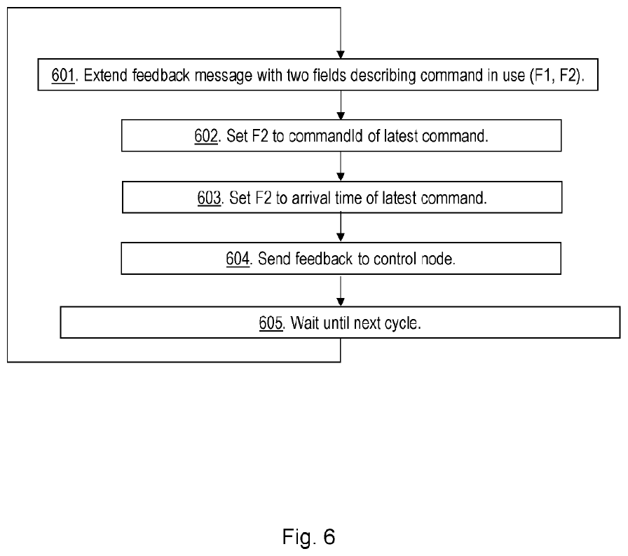

FIG. 6 shows a flowchart showing actions of an example according to some embodiments herein. In this example in FIG. 6, feedback sending in the servo motor associated to the robot device 10 may be performed. The F1 field of the in-use command may be reflected. Furthermore, the current time may be added in the F2 field.

Action 601. Extend the received command message, e.g. feedback message, with two fields describing which command is in use (F1, F2).

Action 602. Set F2 to commandld of a latest command.

Action 603. Set F2 to an arrival time of the latest command.

Action 604. Send feedback to the control node 12.

Action 605. Wait until next cycle.

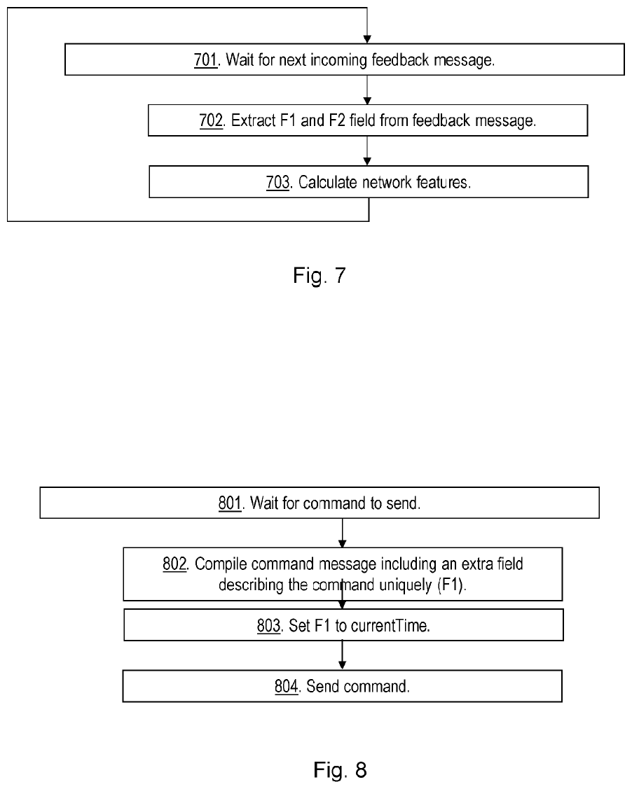

FIG. 7 illustrates a flowchart according to some embodiments where a computation of commandRTT and commandInUseTime in the control node 12 are performed. This may be performed, e.g., executed, when a feedback message is received.

Action 701. Wait for next incoming command message, e.g., feedback message.

Action 702. Extract fields F1 and F2 from the feedback message.

Action 703. Calculate network 40 features:

$$commandRTT = currentTime - F 1 , commandInUseTime = currentTime - F 2.$$

FIG. 8 illustrates a flowchart according to some embodiments. A command sending part may be performed, where a command message may be extended with a time stamp.

Action 801. Wait for command to send.

Action 802. Compile command message including an extra field describing the command uniquely (F1).

Action 803. Set F1 to currentTime.

Action 804. Send the command.

The commandRTT and commandInUse values shown in FIGS. 7 and 8 may be used as follows:
commandRTT may allow the control node 12 to consider the actual network delay and/or jitter condition.
commandInUseTime may allow the control node 12 to consider the actual network loss condition. If commandInUseTime is significantly larger than the cycle time of the controller, then some command messages may be lost.
commandRTT and commandInUseTime may be used for network condition monitoring and in an AI agent as network imperfection features.

There may be synchronized clocks in the control node 12 and the servo motor, e.g., actuator, associated to the robot device 10. If the clocks are not synchronized, then the commandInUse value may be an upper bound which may include a downlink delay component as well.

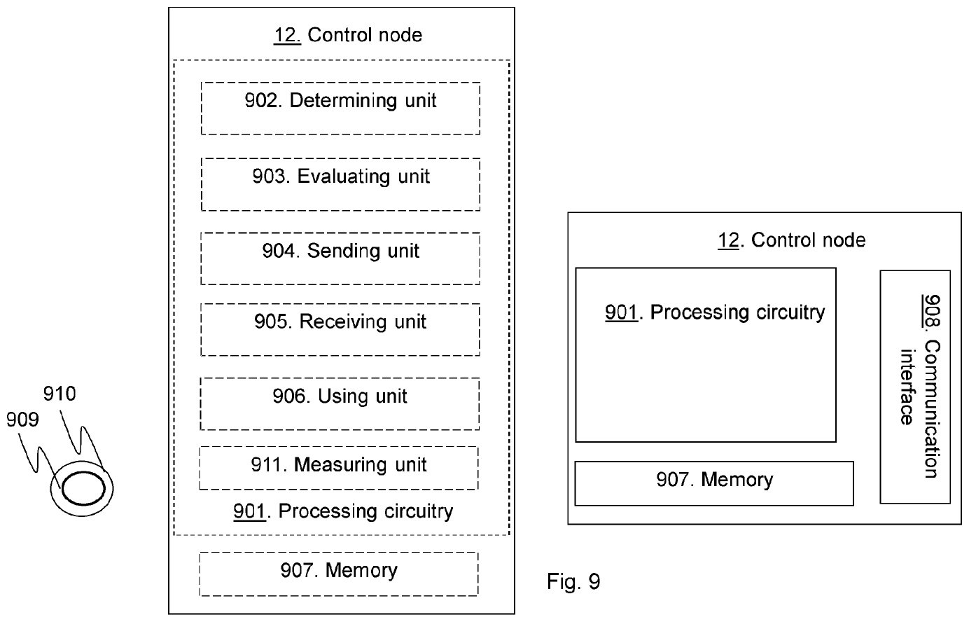

FIG. 9 is a block diagram depicting the control node 12 for handling the performance of the robot device 10, according to embodiments herein.

The control node 12 may comprise processing circuitry 901, e.g. one or more processors, configured to perform the methods herein.

The control node 12 may comprise a determining unit 902. The control node 12, the processing circuitry 901, and/or the determining unit 902 is configured to determine the distance between the planned trajectory and/or path, and the boundary surface, which distance is related to the command message received from the robot device 10, wherein the boundary surface is associated to the accuracy requirement. The determined distance between the planned trajectory and/or path and the boundary surface may be calculated in the Cartesian space. The closest point of the planned path may be used to determine the path distance. The planned trajectory and the realised trajectory may be calculated at the same time point. The determined distance from the planned trajectory and/or path may be measured for one or more points of the planned trajectory where measured position information is available.

The control node 12, the processing circuitry 901, and/or the determining unit 902 may be configured to determine which command that is in use and for how long time the command has been in use, based on the sent command message and the received feedback message comprising the unique hash value.

The control node 12 may comprise a measuring unit 911. The control node 12, the processing circuitry 901, and/or the measuring unit 911 is configured to measure the performance of the trajectory based on the determined distance from the planned trajectory and/or path and the boundary surface.

The control node 12 may comprise an evaluating unit 903. The control node 12, the processing circuitry 901, and/or the evaluating unit 903 is configured to evaluate the effect of the measured performance for the robot device 10.

The control node 12 may comprise a sending unit 904. The control node 12, the processing circuitry 901, and/or the sending unit 904 may be configured to send the command message to the robot device 10, wherein the command message may comprise the unique hash value. The robot device 10 may be the link of a robot arm.

The control node 12 may comprise a receiving unit 905. The control node 12, the processing circuitry 901, and/or the receiving unit 905 may be configured to receive the command message as the feedback to the sent command message, from the robot device 10, wherein the command message may comprise the unique hash value. The control node 12 and the servo motor associated to the robot device 10 may have synchronized clocks.

The control node 12 may comprise a using unit 906. The control node 12, the processing circuitry 901, and/or the using unit 906 may be configured to use the evaluated effect of the measured performance for one or more of: to quantify the quality of execution of the planned trajectory, to monitor the performance of the robot device 10, and/or as trajectory execution quality features input to the artificial intelligence agent.

The control node 12 further comprises a memory 907. The memory 907 comprises one or more units to be used to store data on, such as control command type information, trajectory information, path information, boundary surface information, performance measures, input/output data, metadata, etc. and applications to perform the method disclosed herein when being executed, and similar.

Furthermore, the control node 12 may comprise a communication interface 908 comprising, e.g., a transmitter, a receiver and/or a transceiver.

The method according to the embodiments described herein for the control node 12 is implemented by means of e.g. a computer program product 909 or a computer program, comprising instructions, i.e., software code portions, which, when executed on at least one processor, cause the at least one processor to carry out the actions described herein, as performed by the control node 12. The computer program product 909 may be stored on a computer-readable storage medium 910, e.g. a disc, a universal serial bus (USB) stick or similar. The computer-readable storage medium 910, having stored thereon the computer program product, may comprise the instructions which, when executed on at least one processor, cause the at least one processor to carry out the actions described herein, as performed by the control node 12. In some embodiments, the computer-readable storage medium may be a transitory or a non-transitory computer-readable storage medium.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a control node, for example.

Alternatively, several of the functional elements of the processing units discussed may be provided through the use of dedicated hardware, while others are provided with hardware for executing software, in association with the appropriate software or firmware. Thus, the term “processor”, “control node” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method performed by a control node for handling a performance of a robot device, the method comprising:
determining a distance from one or both of a planned trajectory and path, and determining a distance from a boundary surface, which distances are related to a command message received from a robot device, the boundary surface being associated to an accuracy requirement;
measuring a performance of the trajectory based on the determined distance from one or both of the planned trajectory and path, and the determined distance from the boundary surface; and
evaluating an effect of the measured performance for the robot device.

2. The method according to claim 1, wherein the method further comprises:
using the evaluated effect of the measured performance for one or more of: to quantify a quality of execution of the planned trajectory, to monitor a performance of the robot device, or as trajectory execution quality features input to an artificial intelligence agent.

3. The method according to claim 1, wherein the determined distance from the one or both of the planned trajectory and path, and the determined distance from the boundary surface is calculated in a Cartesian space.

4. The method according to claim 1, wherein a closest point of the planned path is used to determine the path distance.

5. The method according to claim 1, wherein the planned trajectory and a realised trajectory are calculated at a same time point.

6. The method according to claim 1, wherein the determined distance from the one or both of the planned trajectory and path are measured for one or more points of the planned trajectory where measured position information is available.

7. The method according to claim 1, wherein the robot device is a link of a robot arm.

8. The method according to claim 1, further comprises:
sending a command message to the robot device, wherein the command message comprises a unique hash value;
receiving the command message as a feedback to the sent command message, from the robot device, wherein the command message comprises the unique hash value; and
determining which command that is in use and for how long time the command has been in use, based on the sent command message and the received command message comprising the unique hash value.

9. The method according to claim 1, wherein the control node and a servo motor associated to the robot device have synchronized clocks.

10. A control unit for handling a performance of a robot device, the control node being configured to:
determine a distance from one or both of a planned trajectory and path, and determine a distance from a boundary surface, which distances are related to a command message received from a robot device, the boundary surface being associated to an accuracy requirement;
measure a performance of the trajectory based on the determined distance from the one or both of the planned trajectory and path, and the determined distance from the boundary surface; and
evaluate an effect of the measured performance for the robot device.

11. The control node according to claim 10, wherein the control node is further configured to use the evaluated effect of the measured performance for one or more of: to quantify a quality of execution of the planned trajectory, to monitor a performance of the robot device, or as trajectory execution quality features input to an artificial intelligence agent.

12. (canceled)

13. A computer-readable storage medium, having stored thereon a computer program product comprising instructions which, when executed on at least one processor, cause the at least one processor to carry out a method for handing the performance of a robot device, the method comprising:
determining a distance from one or both of a planned trajectory and path, and determining a distance from a boundary surface, which distances are related to a command message received from a robot device, the boundary surface being associated to an accuracy requirement;
measuring a performance of the trajectory based on the determined distance from one or both of the planned trajectory and path, and the determined distance from the boundary surface; and
evaluating an effect of the measured performance for the robot device.

14. The method according to claim 2, wherein the determined distance from the one or both of the planned trajectory and path, and the determined distance from the boundary surface is calculated in a Cartesian space.

15. The control unit of claim 10, wherein the determined distance from the one or both of the planned trajectory and path, and the determined distance from the boundary surface is calculated in a Cartesian space.

16. The control unit of claim 10, wherein the control node is further configured to use a closest point of the planned path to determine the path distance.

17. The control unit of claim 10, wherein the control node is further configured to calculate the planned trajectory and a realised trajectory at a same time point.

18. The control unit of claim 10, wherein the determined distance from the one or both of the planned trajectory and path are measured for one or more points of the planned trajectory where measured position information is available.

19. The control unit of claim 10, wherein the robot device is a link of a robot arm.

20. The control unit of claim 10, wherein the control node is further configured to:
send a command message to the robot device, wherein the command message comprises a unique hash value;
receive the command message as a feedback to the sent command message, from the robot device, wherein the command message comprises the unique hash value; and
determine which command that is in use and for how long time the command has been in use, based on the sent command message and the received command message comprising the unique hash value.

21. The control unit of claim 10, wherein the control node and a servo motor associated to the robot device have synchronized clocks.
